(19) United States
(12) Patent Application Publication
(10) Pub. No.: US 2011/0129807 A1
(43) Pub. Date: Jun. 2, 2011

(54) TOOTHBRUSH TRAINING DEVICE

(76) Inventor: Robert C. Malen, Birmingham, MI (US)

(21) Appl. No.: 12/956,584

(22) Filed: Nov. 30, 2010

Related U.S. Application Data
(60) Provisional application No. 61/265,091, filed on Nov. 30, 2009.

(51) Int. Cl. G09B 23/30

(52) U.S. Cl. 434/263

(57) ABSTRACT

A toothbrush training device that can hold a toothbrush generally includes a base member and a cover member connected to the base member and movable between an open condition and a closed condition. A first container portion includes a chamber at least partially formed by the base member. A first access opening is formed in the cover member. The cover member in the closed condition at least partially aligns the first access opening with the chamber in the base member. The first container portion is operable to receive the toothbrush when the cover member is in the closed condition. A mouth portion includes tooth members that extend from the base member and are exposed when the cover member is in the open condition. The tooth members define a top set opposing a bottom set. Each of the tooth members define a top segment between an outside segment and an inside segment on an exterior of each of the tooth members. The toothbrush training device also includes a first light emitter and a second light emitter. A control module activates at least a first tooth brushing training sequence when the cover member is moved to the open condition from the closed condition to at least partially illuminate the outside segment with the first light emitter and the inside segment with the second light emitter, and to deliver a related audio track that changes when the control module switches from illuminating the first light emitter to illuminating the second light emitter.

### CROSS-REFERENCE TO RELATED APPLICATIONS

This application claims the benefit of U.S. Provisional Application No. 61/265,091, filed on Nov. 30, 2009. The entire disclosure of the above application is incorporated herein by reference.

### FIELD

The present disclosure relates to a toothbrush training device and more specifically relates to a toothbrush training device that can provide a visual and audio guide to young users about the recommended way to brush their teeth.

### BACKGROUND

Children commonly spend too little time brushing their teeth and typically do not completely brush all the surfaces of their teeth. Without proper and consistent parental guidance and prompting, children may grow up without acquiring proper brushing techniques. For example, the American Dental Association recommends that individuals spend at least two minutes brushing their teeth and incorporate a back-and-forth motion when using traditional toothbrushes. When using vibrating or rotating head toothbrushes, a touch-and-hold method should be incorporated.

### SUMMARY

This section provides a general summary of the disclosure, and is not a comprehensive disclosure of its full scope or all of its features.

The present teachings generally include a toothbrush training device that can hold a toothbrush. The toothbrush training device includes a base member and a cover member connected to the base member and movable between an open condition and a closed condition. A first container portion includes a chamber at least partially formed by the base member. A first access opening is formed in the cover member. The cover member in the closed condition at least partially aligns the first access opening with the chamber in the base member. The first container portion is operable to receive the toothbrush when the cover member is in the closed condition. A mouth portion includes tooth members that extend from the base member and are exposed when the cover member is in the open condition. The tooth members define a top set opposing a bottom set. Each of the tooth members define a top segment between an outside segment and an inside segment on an exterior of each of the tooth members. The toothbrush training device also includes a first light emitter and a second light emitter. A control module activates at least a first tooth brushing training sequence when the cover member is moved to the open condition from the closed condition to at least partially illuminate the outside segment with the first light emitter and the inside segment with the second light emitter, and to deliver a related audio track that changes when the control module switches from illuminating the first light emitter to illuminating the second light emitter.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected aspects of the present teachings and not all possible implementations and therefore are not intended to limit the scope of the present teachings.

FIG. 1 is a front view of a toothbrush training device in accordance with the present teachings.

FIG. 2 is a front perspective view of the toothbrush training device of FIG. 1.

FIG. 3 is a rear perspective view of the toothbrush training device with a cover member of FIG. 1 in a closed condition in accordance with the present teachings.

FIG. 4 is a rear view of the cover member in an open condition in accordance with the present teachings.

FIG. 5 is an exploded assembly view of the toothbrush training device of FIG. 1 in accordance with the present teachings.

FIG. 6 is a diagram of a tooth member having a light emitter that illuminates the tooth member in accordance with the present teachings.

FIGS. 7A-7F are diagrams of the tooth members showing portions of the progression of an exemplary toothbrushing training sequence in accordance with the present teachings.

FIGS. 8A-8F are similar to FIGS. 7A-7F and show portions of the progression of the exemplary toothbrushing training sequence in accordance with the present teachings.

FIGS. 9A-9F are also similar to FIGS. 7A-7F and show portions of the progression of the exemplary toothbrushing training sequence in accordance with the present teachings.

FIG. 10 is a diagram of a control module that is connected to an audio emitter and the light emitters to provide the toothbrushing training sequence with an audio portion and a visual portion in accordance with the present teachings.

FIG. 11 is a diagram of an exemplary toothbrushing training sequence in accordance with the present teachings.

FIGS. 12A, 12B, 12C, and 12D are diagrams of multiple alternative appearances of the toothbrush training device including a bear appearance, a kitty appearance, and an elf appearance in accordance with additional aspects of the present teachings.

### DETAILED DESCRIPTION

Various aspects of the present teachings will now be described more fully with reference to the accompanying drawings.

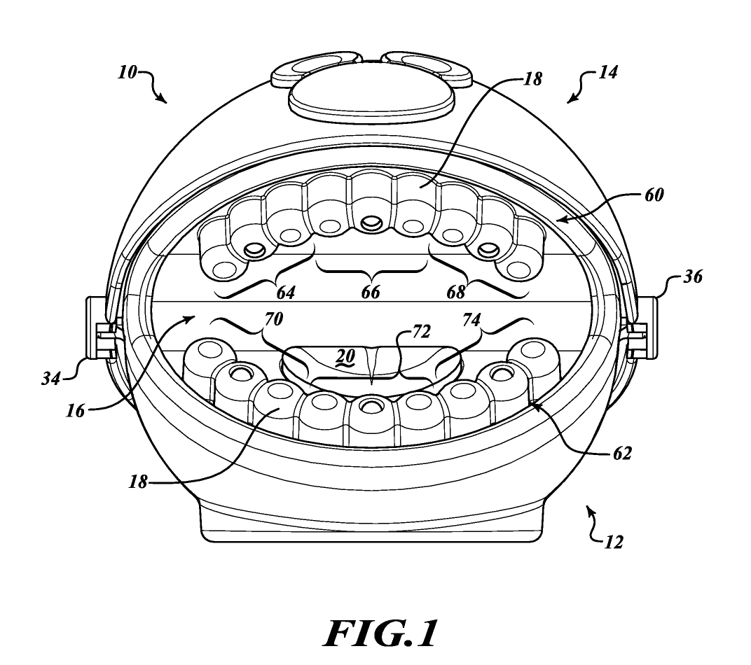

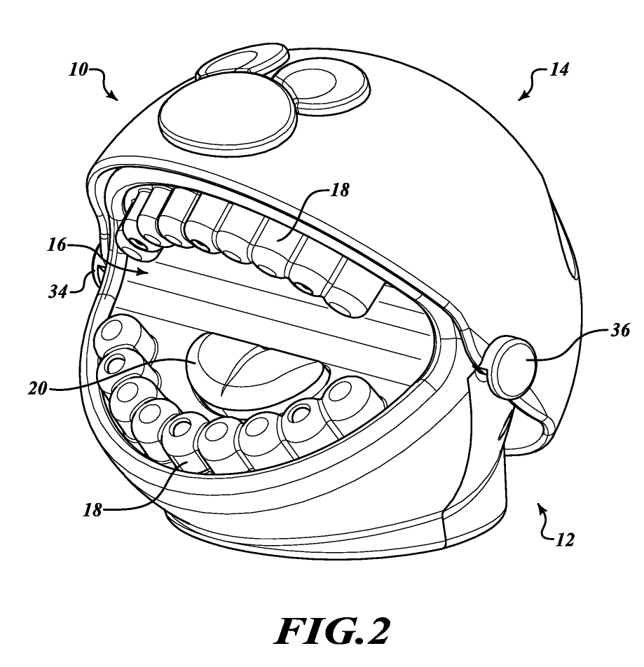

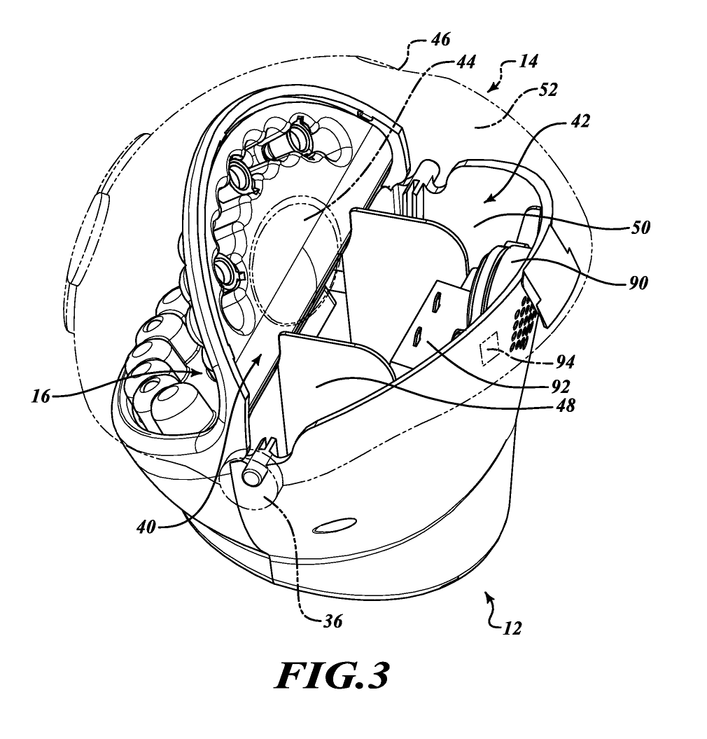

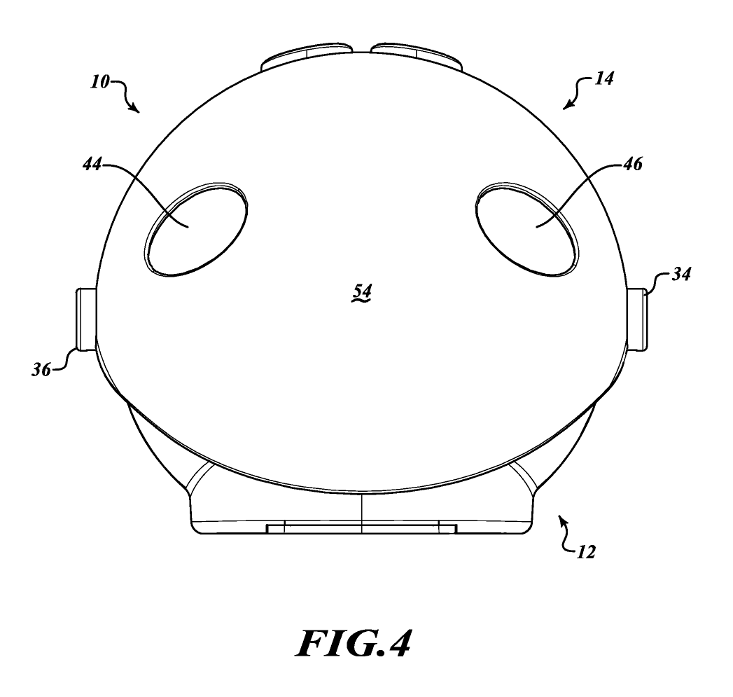

With reference to FIGS. 1 and 2, a toothbrush training device 10 includes a base member 12 and a cover member 14 that can pivot about the base member 12. The cover member 14 can be moved from an open condition (FIGS. 1 and 2) to a closed condition (FIGS. 3 and 4). In the open condition, the base member 12 can present a mouth portion 16 that can have tooth members 18 and a tongue member 20. The base member 12, the cover member 14, and the mouth portion 16 can cooperate to provide a humanoid looking device that can be used to hold toothbrushes, toothpaste, and other suitable bathroom accoutrements and can be used to assist in the instruction of how best to brush your teeth.

With reference to FIGS. 3, 4, and 5, the base member 12 can include a front member 30 and a rear member 32 that can be joined together to form the base member 12. The cover member 14 can be in the form of a hollow partial hemisphere that can rotate about the base member 12. In this regard, two side pins 34, 36 can rotatably connect the cover member 14 to the base member 12. The cover member 14 can be operated manually by a user who can twist one or both of the side pins 34, 36 in a rotating motion to place the cover member 14 in the open condition or in the opposite rotating motion to place the cover member 14 in the closed condition. The cover member 14 can also be moved between the open condition and closed condition by pushing a surface of the cover member 14 to urge the cover member 14 to the open or closed condition, as applicable.

The cover member 14 when moved to the closed condition will remain in the closed condition and similarly when moved to the open condition will remain in the open condition. The cover member 14 can be configured so that its weight alone can hold the cover member 14 in the open condition or in the closed condition or both. In another example, one or more elastic members can be connected between the base member 12 and the cover member 14 to facilitate movement between the open condition and the closed condition. In the closed condition, the cover member 14 can expose a power supply access member 38 that can permit the user to access an area inside the base member 12 to replace batteries and/or store a power cord for connection to a residential power source. The power supply access member 38 can also be accessible from the base member 12.

With reference to FIG. 3, the cover member 14 and the base member 12 can cooperatively define at least a first container 40 and a second container 42. In this regard, the cover member 14 can define a first access opening 44 and a second access opening 46. The base member 12 can define a first cavity 48 and a second cavity 50. When the cover member 14 is in the closed condition, the first access opening 44 can be at least partially aligned with the first cavity 48 and the second access opening 46 can be at least partially aligned with the second cavity 50.

With reference to FIGS. 3 and 4, the access openings 44, 46 on the cover member 14 can be aligned with the cavities 48, 50 on the base member 12, when the cover member 14 is in the closed condition. With the cover member 14 in the closed condition, the user is permitted to insert toothbrushes, toothpaste, etc. into the containers 40, 42. When the cover member 14 is in the open condition, the access openings 44, 46 on the cover member 14 are not aligned and there is no access to the containers 40, 42. Furthermore, when the cover member 14 is in the closed condition and the one or more toothbrushes, toothpastes, etc. are in the one of the containers 40, 42, the cover member 14 is prevented from moving to the open condition. When the cover member 14 is prevented from moving to the open condition from the closed condition, the toothbrush training device 10 is prevented from activating the toothbrushing training sequence, as discussed herein.

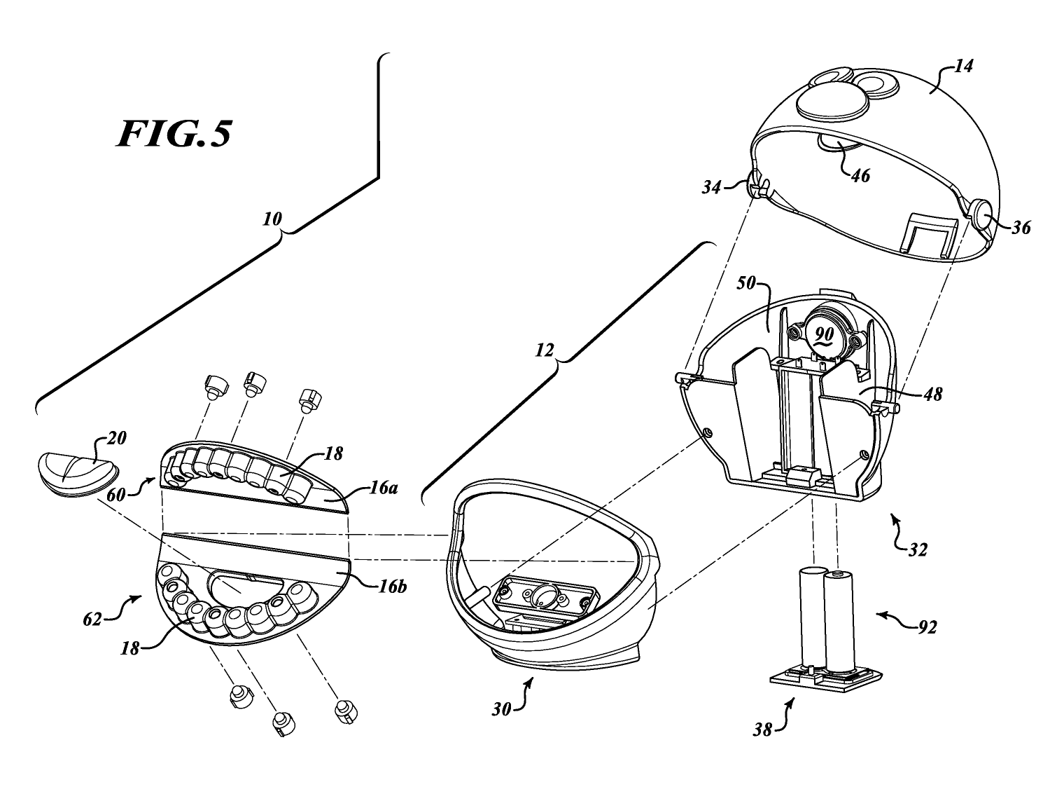

With reference to FIGS. 1 and 5, an upper portion 16a of the mouth portion 16 can contain an upper set 60 of the tooth members 18. A lower portion 16b of the mouth portion can contain a lower set 62 of the tooth members 18. The upper set 60 can have a left portion 64, a middle portion 66, and a right portion 68 of the tooth members 18. The lower set 62 can have a left portion 70, a middle portion 72, and a right portion 74 of the tooth members 18. The portions 64, 66, 68, 70, 72, 74 of the upper and lower sets 60, 62 of the tooth members 18 can each include one of the tooth members 18 or multiple tooth members 18 in each of the sets and/or portions. In one example, the right, middle, and left portions 64, 66, 68, 70, 72, 74 of the upper and lower sets 60, 62 of the tooth members 18 can each include three tooth members 18.

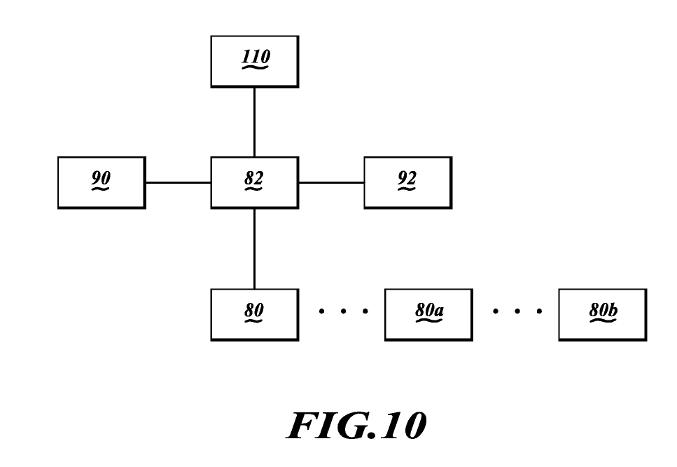

With reference to FIGS. 1, 6, and 10, each of the tooth members 18 or portions of the tooth members 18 can contain one or more light emitters 80. The light emitters 80 can be connected to a control module 82 that can be contained in the base member 12. Additional light emitters 80a, 80b, etc. can be implemented and bundled as suitable. The light emitters 80 can be positioned and secured in an inside cavity 84 of each of the tooth members 18. In another example, one or more of the light emitters 80 can be molded and fixed into one or more of the tooth members 18.

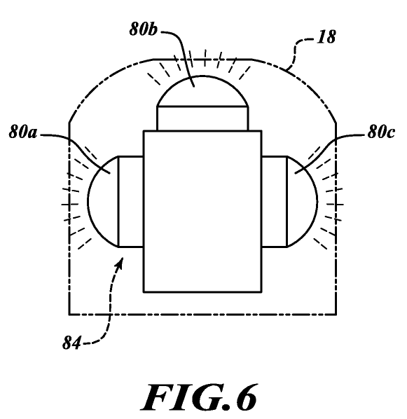

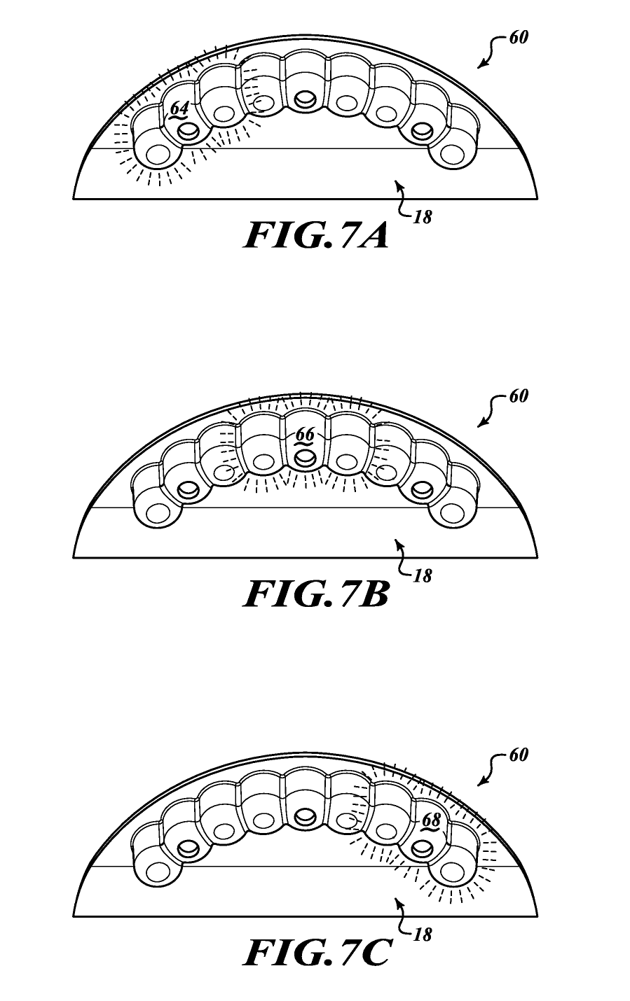

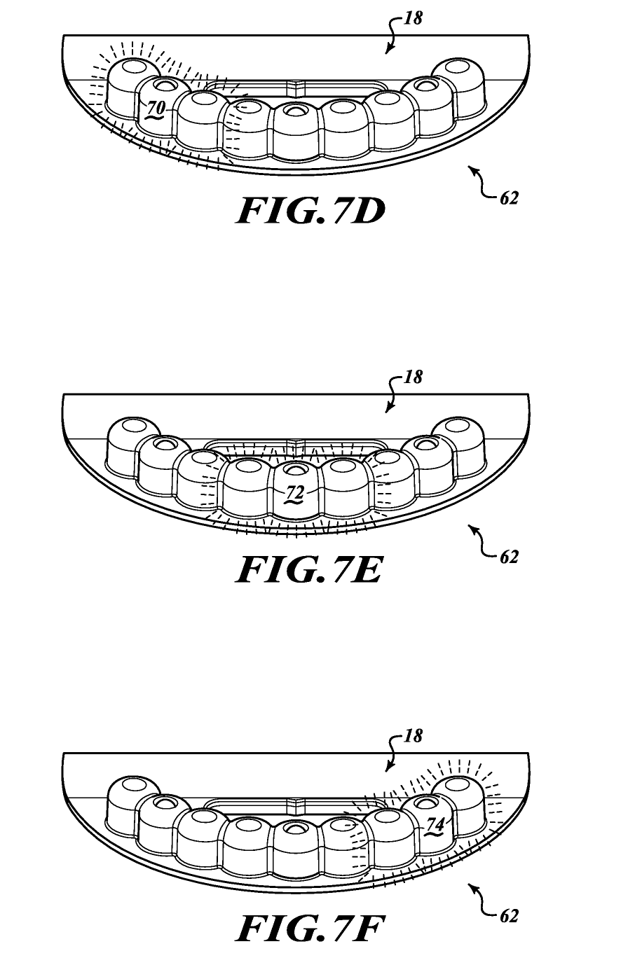

To facilitate the visual perception of the light emitted by the light emitters 80 from the mouth portion 16, the tooth members 18 can be formed of a translucent or a transparent material. The light emitters 80 can be configured so that the user perceives that one of the tooth members 18 are being illuminated or multiple tooth members 18 are being illuminated, as shown in FIGS. 7A-7F. Moreover, the light emitters 80 can be configured to illuminate the upper or lower sets 60, 62 or just one or more of the portions 64, 66, 68, 70, 72, 74 of the upper and lower sets 60, 62 of the tooth members 18.

The control module 82 that connects to the light emitters 80 can also connect to one or more audio emitters 90 and one or more power supplies 92 that can be switched between an on and off position by an external switch. The power supplies 92 can take the form of batteries and/or a direct connection to a residential power source. The light emitters 80 can include, but are not limited to one or more incandescent light bulbs, light emitting diodes, fluorescent lamps, halogen lamps, neon lamps, and/or any other suitable device emitting light that is visually perceptible to the user. The control module 82 can also connect to an input connector 94 that can be accessible on the base member 12. The input connector 94 can be configured to receive via a direct wire connection additional information for the toothbrush training sequence that can include different illumination patterns or audio tracks or both. The control module 82 can also be configured to receive the additional toothbrushing training sequence information via a wireless connection.

In another aspect of the present teachings, each of the tooth members 18 can have tooth segments that make up exterior portions of each of the tooth members 18. In this regard, each tooth member 18 can have an outside segment 100, a top segment 102, and an inside segment 104. With reference to FIG. 6, the light emitters 80 can be installed to individually and selectively illuminate the outside segment 100, the top segment 102, and/or the inside segment 104. Multiple light emitters 80 can be installed in one tooth member to each light up the outside segment 100, the top segment 102, and the inside segment 104. In this regard, the outside segment 100 can be associated with a light emitter 80a, the top segment 102 can be associated with a light emitter 80b, and the inside segment 104 can be associated with a light emitter 80c.

In another example, one or more of the tooth members 18 can be configured so that one of the light emitters 80 can, for example, illuminate the top segment 102, while not illuminating the outside segment 100 or the inside segment 104. In this regard, one or more opaque blockers 106 can be used in each of the tooth members 18 to only allow light to exit from certain segments of the one or more tooth members 18.

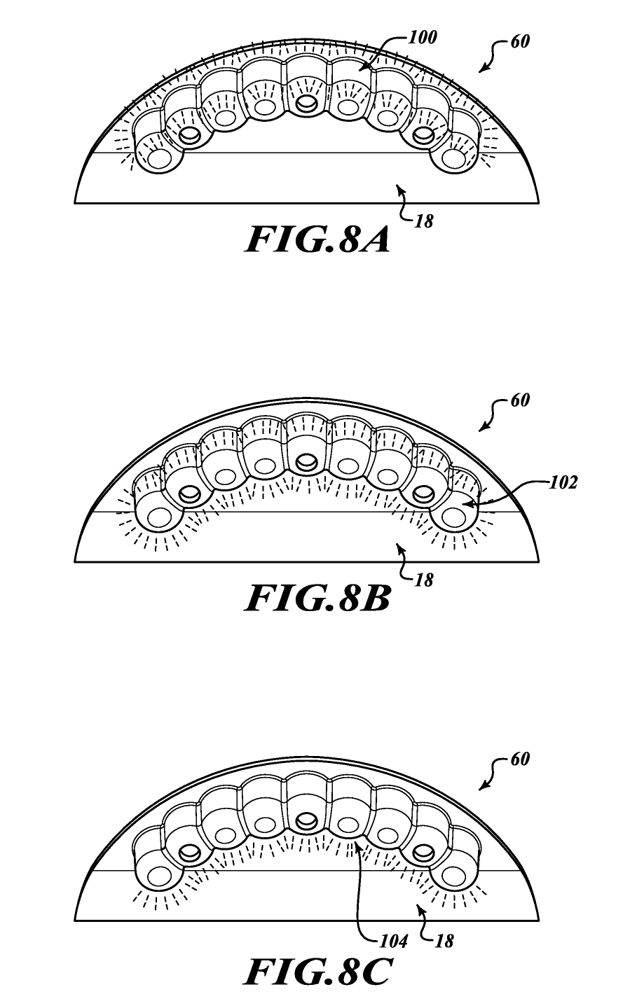

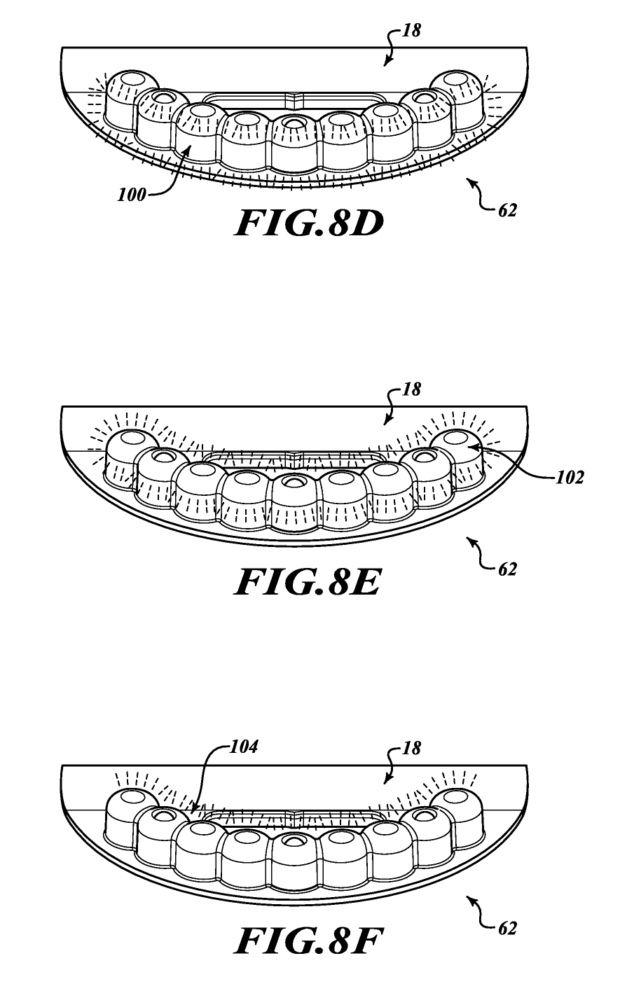

With reference to FIGS. 8A-8F, an exemplary portion of the toothbrushing training sequence can include illuminating the outside segments 100 of the tooth members in the upper set 60. The toothbrush training sequence can progress so that the top segments 102 of the tooth members 18 can be illuminated after the outside segments 100, as shown in FIG. 8B. In

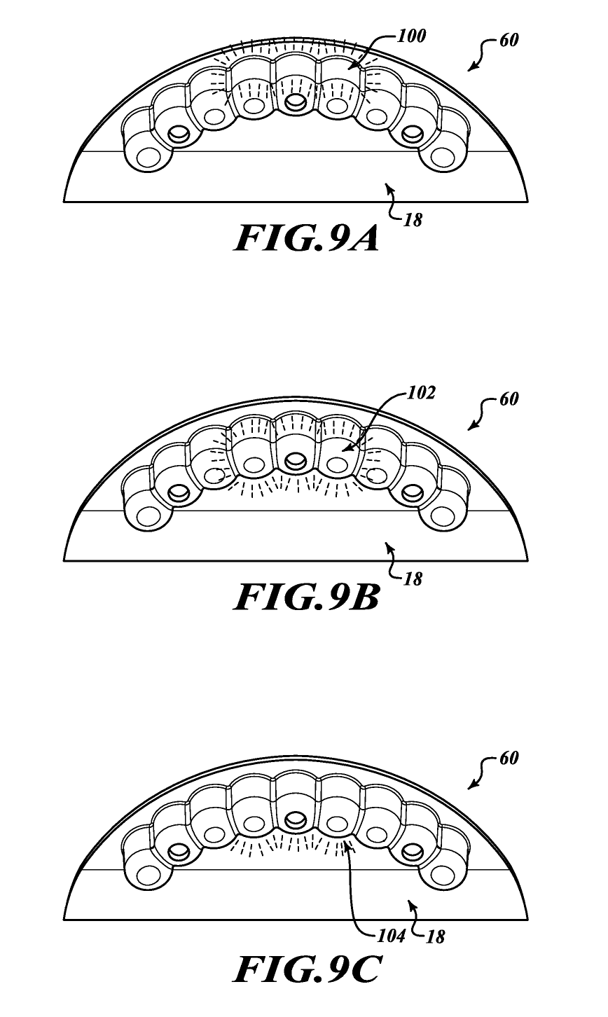

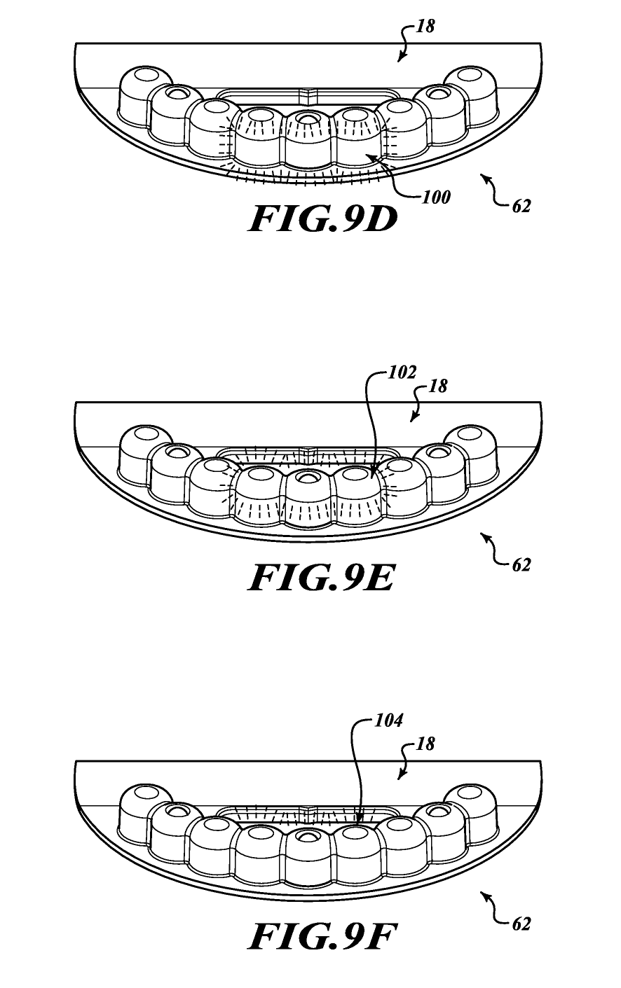

FIG. 8C, the inside segments 102 of each of the tooth members 18 of the upper set 60 are illuminated after the illumination of the top segments 102. In FIG. 8D, the toothbrushing training sequence can continue so that the outside segment 102 of the tooth members 18 in the lower set 62 are illuminated. In FIG. 8E, the top segments of the tooth members 18 in the bottom set are illuminated after the illumination of the outside segment in FIG. 8D. In FIG. 8F, the inside segments 104 of the tooth members 18 of the lower set 62 are illuminated after the illumination of the top segment 102 in FIG. 8E and the outside segment 100 in FIG. 8D. FIGS. 9A-9F show a similar sequence as illustrated in FIGS. 8A-8F, and show the progression for a limited number of the tooth members 18.

In operation, the user can turn on the toothbrush training device 10 and activate a toothbrushing training sequence after removing the toothpaste and/or the toothbrush from the containers 40, 42 cooperatively formed by the base member 12 and the cover member 14. To that end, the user can rotate the right side and/or the left side pins 34, 36 to move the cover member 14 rearward to the open condition. In doing so, the user can move the cover member 14 to reveal the mouth portion 16. When the cover member 14 is in the open condition, the cover member 14 can contact a switch 110 (FIG. 8) to, in turn, activate the toothbrushing training sequence. By activating the switch 110, the control module 82 can execute the toothbrushing training sequence that can include a pre-determined progression of light illumination from the one or more light emitters 80 and also a pre-determined progression of voice instructions, prompts, and reassurances through the one or more audio emitters 90.

The audio portion of the toothbrushing training sequence can include voice prompts. Each of the voice prompts can be timed to direct the user to brush the user's entire set of teeth (or portions thereof) by instructing the deliberate brushing of each of the teeth and all of the locations on the teeth. In this regard, the light emitters 80 can illuminate one or more of the outside segment 100, the top segment 102, or the inside segment 104 in concert with the audio portion. The combination of the audio portion and the visual portion in the toothbrushing training sequence can provide a “follow-the-leader” fashion of instruction that can be shown to facilitate more complete participation by the user in thoroughly and properly brushing their teeth.

Upon completion of the toothbrushing training sequence, the cover member 14 can be returned to the closed condition. Prior to completion of the toothbrushing training sequence, the user can also move the cover member 14 from the open condition to the closed condition and terminate the toothbrushing training sequence by deactivating the switch 110.

In one example, the toothbrushing training sequence can include the following progression through the audio and visual components of the toothbrushing instruction. After the switch 110 is activated by moving the cover member 14 to the open condition, the one or more audio emitters 90 can announce an introduction. The introduction can be: “Hello, Get ready to brush. Let's brush our top teeth first. Start on the left.” In tandem with the audio portion, the control module 82 can cause one or more of the light emitters 80 to illuminate the left portion 64 of the upper set 60 of the tooth members 18, as shown in FIG. 7A. The illumination of the left portion 64 of the upper set 60 of the tooth members 18 can take the form of a flashing pattern for a specific time during which the user can be expected to brush only the subset of the tooth members 18 (e.g.: the left portion 64) that are illuminated and are also the subject of the audio portion.

While the user is instructed to brush the left portion 64 of the upper set 60 of the tooth members 18, additional voice prompts can be provided to remind the user to brush the inside, outside and top surfaces of their teeth. In this regard, the control module 82 can illuminate the inside, outside and/or top segments 100, 102, 104 of the one or more tooth members 18 in tandem with the audio portion instructing the brushing of the segments 100, 102, 104.

The illumination of the left portion 64 of the upper set 60 of the tooth members 18 can continue for the suggested time period to encourage continued brushing even though the audio portion may not include instruction during the entire period. During the period, when there is no audio instruction being emitted by the one or more audio emitters 90, the control module 82 can cause the one or more audio emitters 90 to emit sounds of brushing or scrubbing teeth to further encourage the user to continue brushing until the expiration of the period. When the period has expired, the audio portion can prompt the user to move on to the next location. Prompting the user to move on to the next location can be in the form of: “Okay, good job, now let's brush the top teeth in the middle.”

In tandem with the audio portion of the toothbrushing sequence, the control module 82 can cause one or more of the light emitters 80 to illuminate the middle portion 66 of the upper set 60 of the tooth members 18, as shown in FIG. 7B. While the user is instructed to brush the middle portion 66 of the upper set 60 of the tooth members 18, additional voice prompts can be provided to remind the user to brush the inside, outside and top surfaces of their teeth. When the period has expired, the audio portion can prompt the user to move on to the next location. Prompting the user to move on to the next location can be in the form of: “Okay, good job, now let's brush the top teeth on the right.” The tooth brushing sequence can similarly continue to the right portion 68 of the upper set 60 (FIG. 7C), and then follow with the lower set 62 of the tooth members 18. The toothbrushing training sequence can follow with the left portion 70 (FIG. 7D), the middle portion 72 (FIG. 7E), and the right portion 74 (FIG. 7F) of the lower set 62 of the tooth members 18 in tandem with the related audio program.

The toothbrushing training sequence that includes the audio instruction and the selective illumination discussed throughout can continue until expiration of the period has been reached for each of the surfaces of teeth to be completely brushed. At the end of the toothbrushing training sequence, the audio portion can announce: “Don't forget to rinse . . . Great job! Your teeth look sparkling clean! See you soon!”

In one example, the control module 82 can be configured and re-configured so that multiple varieties of voices and instruction styles can be implemented. The control module 82 can also be configured so that voices and instruction can be recorded and re-recorded by the user or related persons, so that the user receiving the instruction can hear a familiar voice, e.g.: the voice of a parent, grandparent, or dental practitioner. An input connector 94 can be connected to the control module 82 so that additional audio tracks or illumination sequences or both can be uploaded. The control module can receive additional audio tracks or illumination sequences or both via a wired connection to the input connector 94 or directly via a wireless connection.

In a further aspect of the present teachings, one or more of the tooth members 18 can be made of a plastic material that can change color in response to a difference in temperature. In this regard, the one or more tooth members 18 can change color as one or more of the light emitters 80 contained within the one or more tooth members 18 generate heat. In doing so, one color of the one or more tooth members 18 could represent “dirty teeth” prior to brushing. The one or more tooth members 18 are then illuminated for a period while the user brushes their teeth. While illuminated, the one or more tooth members 18 can change in color to present “clean teeth” to the user at the end of the instruction of that portion of the tooth members 18.

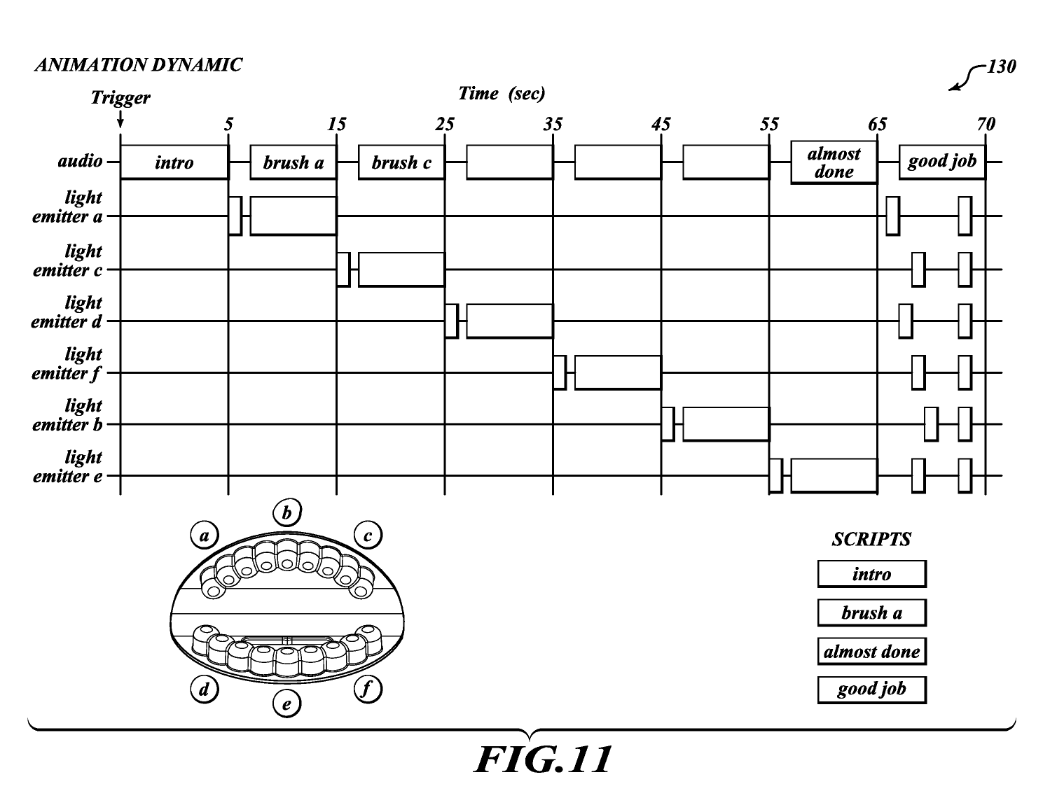

The toothbrushing training sequence can be configured (or re-configured) to alter the period of instruction to increase or decrease the total amount of time the toothbrushing training device asks the user to brush their teeth. The commonly recommended two-minute brush time can be implemented but shorter or longer brush times can also be implemented. For younger users, e.g.: a three-year-old child, a thirty second period could be implemented. FIG. 11, for example, shows a diagram 130 illustrating multiple periods in which one or more of the tooth members 18 can be illuminated in concert with selected audio portions during the illumination. In this regard, the user may configure the control module 82 (FIG. 8) so that each period in which a portion of the tooth members 18 are illuminated can be adjusted and re-adjusted at will by the user. The user can also configure and re-configure the succession of the toothbrushing training sequence so certain portions of the tooth members can be illuminated prior to or after other portions of tooth members. The related portions of the audio instruction can follow the rearranged succession of illumination.

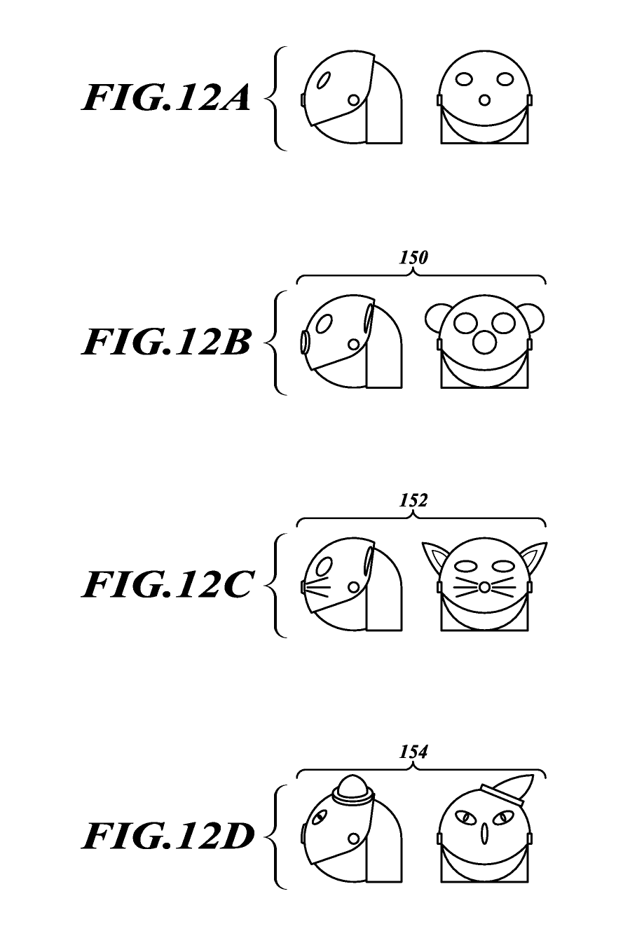

With reference to FIGS. 12A-12D, an exterior look of the toothbrush training device 10 can be modified to add or subtract different surface colors, hair, eyeglasses, hats, facial features, and/or other applicable features of the humanoid appearance in accordance with further aspects of the present teachings. The toothbrush training device can be configured so that various animals, sports, and popular characters can be implemented in lieu of the humanoid appearance. In one example, the cover member 14 can be substituted with a cover member 150 that can have an appearance similar to a bear. The cover member 14 can also be replaced with a cover member 152 that can have the appearance similar to a kitten. The cover member 14 can also be replaced with the cover member 154 that can have the appearance similar to an elf.

In a further example, the cover member 14 can be replaced with a cover member that resembles a type of sports equipment such as, but not limited to, a soccer ball, a baseball, a basketball, a football, and/or combinations thereof. In yet another example, the cover member 14 can be replaced with a cover member that resembles one or more foods like fruits and vegetables such as, but not limited to, an apple, an orange, a pineapple, and/or combinations thereof. In another example, the cover member 14 can be replaced with a cover member that resembles one or more animals such as, but not limited to, a mouse, a bear, a cat, a dog, and/or combinations thereof.

While specific aspects have been described in the specification and illustrated in the drawings, it will be understood by those skilled in the art that various changes can be made and equivalents can be substituted for elements and components thereof without departing from the scope of the present teachings, as defined in the claims. Furthermore, the mixing and matching of features, elements, components and/or functions between various aspects of the present teachings are expressly contemplated herein so that one skilled in the art will appreciate from the present teachings that features, elements, components and/or functions of one aspect of the present teachings can be incorporated into another aspect, as appropriate, unless described otherwise above. Moreover, many modifications may be made to adapt a particular situation, configuration, or material to the present teachings without departing from the essential scope thereof. Therefore, it is intended that the present teachings not be limited to the particular aspects illustrated by the drawings and described in the specification as the best mode presently contemplated for carrying out the present teachings, but that the scope of the present teachings include many aspects and examples following within the foregoing description and the appended claims.

Example aspects of the present teachings are provided so that this disclosure will be thorough, and will fully convey the scope to those who are skilled in the art. Numerous specific details are set forth such as examples of specific components, devices, and methods, to provide a thorough understanding of the aspects of the present teachings. It will be apparent to those skilled in the art in light of the disclosure that specific details need not be employed, that example aspects may be embodied in many different forms and that neither should be construed to limit the scope of the teachings. In some example aspects, well-known processes, well-known device structures, and well-known technologies are not described in detail.

The terminology used herein is for the purpose of describing particular example aspects only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer, or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

As used herein, the term module may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

What is claimed is:

1. A toothbrush training device that can hold a toothbrush, the toothbrush training device comprising:
a base member;
a cover member connected to said base member and movable between an open condition and a closed condition;
a first container portion including a chamber at least partially formed by said base member;
a first access opening formed in said cover member, said cover member in said closed condition at least partially aligns said first access opening with said chamber in said base member, said first container portion operable to receive the toothbrush when said cover member is in said closed condition;
a mouth portion including tooth members that extend from said base member and are exposed when said cover member is in said open condition, said tooth members defining a top set opposing a bottom set, each of said tooth members define a top segment between an outside segment and an inside segment on an exterior of each of said tooth members;
a first light emitter and a second light emitter; and
a control module that activates at least a first toothbrushing training sequence when said cover member is moved to said open condition from said closed condition to at least partially illuminate said outside segment of one of said tooth members with said first light emitter and said inside segment of another of said tooth members with said second light emitter, and to deliver a related audio track that changes when said control module switches from illuminating said first light emitter to illuminating said second light emitter.

2. The toothbrush training device of claim 1, wherein said cover member is operable to prevent activation of said first toothbrushing training sequence until the toothbrush is removed from said first container portion.

3. The toothbrush training device of claim 1, wherein said top set of said tooth members includes a middle portion between a right portion and a left portion, said first toothbrushing training sequence includes illuminating said left portion while said middle portion and said right portion are not illuminated, illuminating said middle portion while said left portion and said right portion are not illuminated, and illuminating said right portion while said middle portion and said left portion are not illuminated.

4. The toothbrush training device of claim 3, wherein said bottom set of said tooth members includes a middle portion between a right portion and a left portion, said first toothbrushing training sequence includes illuminating said middle portion of said bottom set and not illuminating said right portion and said left portion of said bottom set and all of said tooth members of said top set, illuminating said left portion of said bottom set and not illuminating said middle portion and said right portion of said bottom set and all of said tooth members of said top set, and illuminating said left portion of said bottom set and not illuminating said middle portion and said right portion of said bottom set and all of said tooth members of said top set.

5. The toothbrush training device of claim 1, wherein said first toothbrushing training sequence includes illuminating said outside segment of all of said tooth members in said top set while not illuminating said inside segment and said top segment of said tooth members in said top set and all of said tooth members in said bottom set.

6. The toothbrush training device of claim 1 further comprising a second container portion including a chamber at least partially formed by said base member and a second access opening formed in said cover member, said cover member in said closed condition at least partially aligns said second access opening with said chamber of said second container portion, said cover member is operable to prevent activation of said toothbrushing training sequence until the toothbrush is removed from said second container portion.

7. The toothbrush training device of claim 1, wherein said cover member is operable to interrupt said first toothbrushing training sequence when moved from said open condition to said closed condition, end said audio track, and not illuminate all of said tooth members in said top set and said bottom set.

8. The toothbrush training device of claim 1, wherein said audio track in said first toothbrushing training sequence is descriptive of said tooth members currently illuminated.

9. The toothbrush training device of claim 1, wherein said audio track includes sounds of brushing and scrubbing teeth while at least one of said tooth members is illuminated.

10. The toothbrush training device of claim 1, wherein said audio track includes a prompt for a user to move onto a new location in said mouth portion.

11. The toothbrush training device of claim 1 further comprising an input connector connected to said control module, said input connector operable to receive additional toothbrushing training sequences, said additional toothbrush training sequences including additional audio tracks.

12. The toothbrush training device of claim 11, wherein said additional audio tracks include a voice of a user.

13. The toothbrush training device of claim 1, wherein at least one of said tooth members changes color when illuminated.

14. The toothbrush training device of claim 1, wherein said control module is operable to reduce a period in which said first toothbrushing training sequence operates.

15. The toothbrush training device of claim 1 further comprising a plurality of cover members, each of said cover members in said plurality of cover members each have a different face.

16. A method of toothbrush training with a toothbrush training device that can hold a toothbrush, the method comprising:
providing a cover member connected to a base member and movable between an open condition and a closed condition;
removing the toothbrush from a chamber of a first container portion in said base member to permit movement of said cover member from said closed condition to said open condition;
opening said cover member to said open condition to expose a mouth portion including tooth members that extend from said base member;
activating a first toothbrushing training sequence when said cover member is moved from said closed condition to said open condition;
illuminating an outside segment of one of said tooth members with a first light emitter;
illuminating an inside segment of another of said tooth members with a second light emitter and extinguishing said illumination of said outside segment of one of said tooth members with said first light emitter; and
delivering a related audio track that changes upon said extinguishing said illumination of said outside segment of one of said tooth members with said first light emitter.

17. The method of claim 16 further comprising preventing activation of said first toothbrushing training sequence until the toothbrush is removed from said first container portion.

18. The method of claim 16 further comprising illuminating a left portion of a top set of tooth members while a middle portion and a right portion of said top set of said tooth members are not illuminated, illuminating said middle portion while said left portion and said right portion are not illuminated, and illuminating said right portion while said middle portion and said left portion are not illuminated.

19. The method of claim 18 further comprising illuminating a middle portion of a bottom set of said tooth members and not illuminating a right portion and a left portion of said bottom set and all of said tooth members of said top set, illuminating said left portion of said bottom set and not illuminating said middle portion and said right portion of said bottom set and all of said tooth members of said top set, and illuminating said left portion of said bottom set and not illuminating said middle portion and said right portion of said bottom set and all of said tooth members of said top set.

20. The method of claim 16 further comprising changing the color of one of said tooth members when illuminated.
